(19) United States
(12) Patent Application Publication
(10) Pub. No.: US 2026/0283065 A1
(43) Pub. Date: Sep. 24, 2026

(54) TAILORED IN-FURROW PRODUCT DELIVERY SYSTEM AND METHOD FOR A POTATO PLANTER

(71) Applicant: BLUEFIELD SEEDING SOLUTIONS INC., Brookfield (CA)

(72) Inventor: Robert Craig MCCLOSKEY, North Wiltshire (CA)

(21) Appl. No.: 19/168,048

(22) PCT Filed: Mar. 19, 2024
(86) PCT No.: PCT/CA2024/000003

§ 371 Date: Sep. 23, 2025

Related U.S. Application Data
(60) Provisional application No. 63/455,312, filed on Mar. 29, 2023.

(51) Int. Cl. A01C 5/06

(52) U.S. Cl. CPC A01C 5/068

(57) ABSTRACT

A potato planter has a tailored, 3D-precision, in-furrow product delivery system mounted thereon. The in-furrow product delivery system is operated by a controller that is configured for analysing a pressure signature received from a pressure sensor in the press wheel of the planter and for determining characteristics of the seed pieces and the amount and location of in-furrow product required by each seed piece. The dispensing of in-furrow product is selectively done in two or three dimensions. The dispensing of in-furrow product is done in symmetrical horizontal placements and symmetrical volumes relative to the centroid of the seed piece. The dispensing can also be done in a third dimension, on the floor of the furrow or over a layer of soil of selective thickness over the seed piece.

The present application claims the benefit of U.S. Provisional Application #63/455,312 filed Mar. 29, 2023.

### FIELD OF THE INVENTION

This invention pertains to in-furrow product applications to agricultural crops, and more particularly it pertains to calibrated in-furrow product applications at machine-planting speeds.

### BACKGROUND OF THE INVENTION

Precision agriculture is a way of thinking and working in a modern farming society. Technological advances, economic conditions and environmental stresses put pressure on every farmer. A common goal nowadays is to improve performance while reducing costs.

An important aspect of precision agriculture is to limit the application of in-furrow product to the anticipated location of the root system of a planted seed, as opposed to a broadcast or banded application.

Examples of systems found in the prior art for selective application of in-furrow products include:

### Using Seed Sensor in the Seed Tube

US 2021/0,059,107 published on Mar. 4, 2021;

US 2004/0,231,575 published on Nov. 25, 2004.

### Detecting Seeds on the Ground

US 2020/0,253,107 published on Aug. 13, 2020;

WO 2019/050,944 published on Mar. 14, 2019.

In the industrial machines found in the prior art, the exact location of a seed is detected by proximity detectors, accelerometers, electro-magnetic sensors, optical detectors or by synchronization with seed drop, and granular or liquid in-furrow products are applied directly over the seed and/or on the soil at close proximity of the seed.

Although the prior art contains many concepts of seed planters with selective in-furrow product delivery, these planters are designed for small seeds such as corn, beans, and peas. None of these machines is applicable to potato planting. Therefore, it is believed that there is a market need for a potato planter capable of sparingly applying in-furrow product to potato sets.

Potato seed pieces are known in the agricultural language as potato sets or planted sets. A “set” represent a small tuber or part of a tuber. For convenience, the word “set” is used interchangeably herein with seed and seed piece, for designating any plant precursor that is planted in the ground for the purpose of producing crops. Therefore, the expressions “potato set”, “planted set”, “seed piece” or “potato seed” are used herein to describe a same thing in a description of a preferred embodiment and should not be interpreted as a limitation of the present invention.

Similarly, the expression “in-furrow product” as used herein is meant to be understood as starter-type fertilizer product, nitrogen-based agricultural product, phosphorous-based agricultural product, biological additives, pesticides, insecticides, fungicides or any other seed-amendment product, plant treatment product, or crop protecting product either in a liquid form, gel form, granular form, or powdery form. The above products are also referred to collectively as in-furrow products or agricultural products, in a description of a preferred embodiment. The placement of in-furrow product as illustrated in the attached drawings is to be understood as an agricultural product that is placed near the seed piece without touching the seed pieces, or over the seed piece, applied in dashes, in elongated bands between, alongside or over the seed pieces, or on top of the furrow.

Typically, high phosphorous and nitrogen fertilizers are needed during the earlier growth stages of a potato plant. These agricultural products are usually liquid based fertilizers and are applied in furrow either in a sprayed form directly on the seed pieces or in a banded form on either side of the plants before row closure. Currently, the standard practice is to do a continuous liquid spray or band of these products, without stopping between plants. Because these products are needed immediately after the potato sets start to sprout, the products that are sprayed between the seeds are not used as efficiently as the products that is placed closer to the new plants. This example illustrates a market need for a potato planter capable of sparingly applying in-furrow products to potato sets, to reduce waste.

### SUMMARY OF THE INVENTION

The potato planter of interest herein is described in the following documents.

U.S. Pat. No. 9,258,940 issued to the present inventor on Feb. 16, 2016;

U.S. Pat. No. 9,930,826 issued to the present inventor on Apr. 3, 2018, and

US Application 2021/0,007,273, published by the present inventor on Jan. 14, 2021. All these documents are included herein by reference.

The potato planer of interest herein has a relatively wide furrow-opening shoe and a press wheel mounted behind the furrow-opening shoe and a seed delivery chute, to check a set roll in planted sets. The press wheel is an inflated wheel capable of deformation when rolling over a planted set. The inflated wheel has a pressure sensor mounted thereto capable of detecting a deformation in the wheel upon the wheel rolling over a planted set. The press wheel is mounted to a structure that allows the adjustment of ground pressure by the wheel.

The present application describes a potato planter with a tailored in-furrow product delivery system that is controlled by the pressure sensor mounted to the press wheel of the planter, and a controller that is configured for analysing the pressure signature received from the pressure sensor when the wheel rolls over a planted set, and for associating the pressure signature to the physical characteristics of the planted set, the exact position of the planted set and of the centroid of the planted set relative to the location of the planter, and determining the optimum amount/volume and ideal placement of in-furrow product required by the seed piece, according to the above-mentioned detected physical characteristics.

In another aspect of the present potato planter with a tailored in-furrow product delivery system is that those physical characteristics of a planted seed piece is determined from a group of characteristics comprising, a small seed piece, an average size seed piece, a large seed piece, a missing seed piece, a double drop seed piece, a no-drop furrow space and a seed piece imperfection.

As mentioned, a common characteristic detected for each planted set is the centroid of each planted set relative to the position of the planter. The root systems of a plant tend to grow symmetrically relative to the centroid of that plant, and therefore in-furrow product placement in the present invention is done symmetrically to the centroid of a planted sets for a more efficient absorption of the product by the root systems of plants.

In a further aspect of the present potato planter with a tailored in-furrow product delivery system, a response time between the step of causing the inflated press wheel to generate a pressure signature and the step of dispensing in-furrow product to a seed piece is 35 to 90 milliseconds.

In yet other aspects of the present potato planter with a tailored in-furrow product delivery system is that an in-furrow product delivery is done in both symmetrical distance and symmetrical volume relative to the centroid of the planted set, along a horizontal plane of the planted surface.

The tailored product delivery is done on a rolled planted surface having a reduced permeability to liquids, for delayed downward absorption of the agricultural product by planted sets. In a further dimension, the tailored in-furrow product delivery is done over a selective thickness of soil covering the planted set, for a delayed leaching of the product to the planted set.

The dispensing of in-furrow product is done in symmetrical horizontal placements and symmetrical volumes relative to the centroid of the seed piece. The dispensing can also be done in a third dimension, on the floor of the furrow or over a layer of soil of selective thickness, or both.

This summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 is a partial side view of the potato planter of interest herein, equipped with a tailored in-furrow granular product delivery system;

FIG. 2 is an example of a pressure signature given by instrument in the press wheel of the preferred planter upon rolling over a planted set;

FIGS. 3 and 4 are representations of the press wheel of the preferred planter in FIG. 1 rolling over different seed piece sizes and planting events, with their corresponding pressure signatures;

FIGS. 5 and 6 show representations of in-furrow product delivery pattern with two different types of in-furrow granular products;

FIG. 7 represents a typical potato set with two potato eyes;

FIG. 8 represents different slopes of the hyperbolic entry segment of a typical pressure signature from the press wheel, according to different seed piece sizes;

FIG. 9 is a partial schematic illustration of a liquid-form in-furrow product delivery system;

FIG. 10 is a partial side view of the press wheel of the preferred planter with a partial view of liquid-form in-furrow product delivery nozzles;

FIG. 11 illustrates a press wheel and a series of nozzles for dispensing liquid agricultural products mounted to a structure associated with the press wheel;

FIG. 12 is a perspective view of one example of an in-furrow product delivery pattern;

FIG. 13 is another perspective view of a second example of an in-furrow product delivery pattern;

FIG. 14 is a plan view of an in-furrow product delivery pattern.

FIG. 15 is a partial cross-section view of the preferred planter and a partial cross-section view of a furrow, showing a typical amount of soil being pushed over a planted set by the closing discs, closing discs or spades of the planter during closing of the furrow;

FIG. 16 is a schematic see-through image of a planted set in a furrow and three-dimensional placements of in-furrow product wherein a first layer is dispensed on the floor of the furrow and other alternative options are shown at different spacings above the planted set.

### DETAILED DESCRIPTION OF THE PREFERRED EMBODIMENT

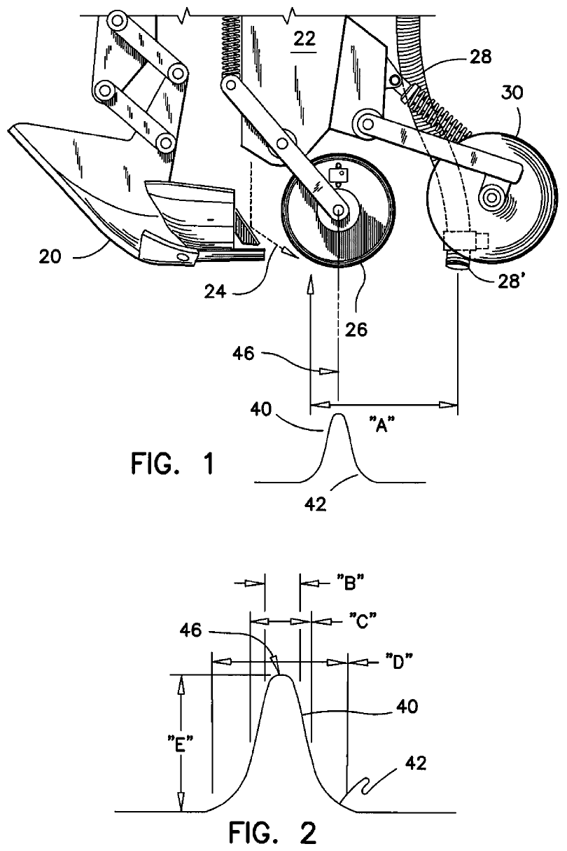

Referring to FIG. 1, the preferred potato planter has a wide furrow-opening shoe 20, a seed delivery tower 22 from which seeds are singularly dropped along the illustrated seed path 24. Seed pieces are directed immediately under a press wheel 26 such as to prevent set roll thereof along the furrow. A in-furrow product hose 28 from an in-furrow product hopper (not shown) extends between the coulter discs 30, or at any other convenient location, to deliver in-furrow product to the planted sets before the furrow is closed. This in-furrow product delivery hose 28 preferably has a rotary valve, a pump, or a similar quick-response actuator (not shown) on its bottom end 28′, for immediate delivery of in-furrow product upon receiving a delivery command. Although the expression “coulter discs” is used herein, “closing discs” and “spades”, or a combination of discs and spades are also used on some planters.

The press wheel 26 in the preferred potato planter is inflated and has a sensitive pressure sensor (not shown) mounted therein or thereto to measure the deformation of the press wheel upon rolling over a planted set, and to transmit pressure data to a controller (not shown). The controller includes a clock and a connection to the speedometer of the planter to record the pressure signal relative to the location and speed of the planter.

As it can be appreciated, the pressure sensor in or on the press wheel generates a first readable waveform signal 40 at a very early stage during the initial contact of the press wheel with the seed piece. This first signal occurs during the wave entry segment 42 of the unidirectional waveform illustrated in FIGS. 1 and 2.

The first signal 42 precedes the formation of a complete waveform 40 representing the full deformation of the wheel surface, upon rolling of the press wheel over the planted set.

Referring again to FIG. 1, the first readable signal occurs at a comfortable lead time ‘A’ before the position of the nozzle of the in-furrow product delivery hose, to enable the delivery of in-furrow product at a fair distance ahead of the seed piece location.

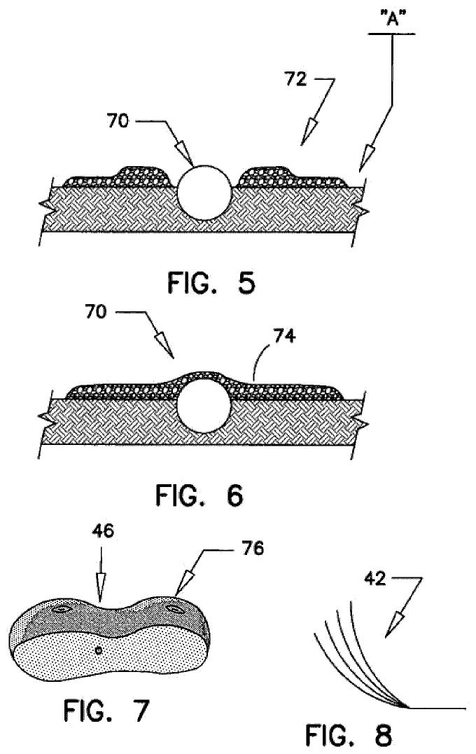

The use of a press wheel 26, a pressure sensor, controller and data transmission offer many advantages over optical sensors, accelerometer, magnetic and proximity detectors used in the planters found in the prior art, as may be understood from the illustration of FIG. 2. The waveform signature 40 illustrated therein is a typical unidirectional waveform signature given by the pneumatic sensor. This waveform has hyperbolic entry and exit segments 42 and an elliptical crest. The curvature and slope of the hyperbolic wave entry segment 42 can be interpreted to obtain a first approximation of the size of the seed piece, as explained later in reference to FIG. 8. The peak width ‘B’ of the wave 40 and the peak width ‘C’ at half height can also be interpreted to determine the final size and shape of a seed piece. The period ‘D’ and amplitude ‘E’ are also indicative of potato set characteristics.

The maximum amplitude “E” is a high pressure point of waveform 40. This point represents a high point on a seed piece. This point is a reliable approximation of a centre of mass, a centre of gravity, a centre of volume, a middle point of a planted set, a middle point of a double seed drop, and it is referred to herein as a centroid 46 of a planted set.

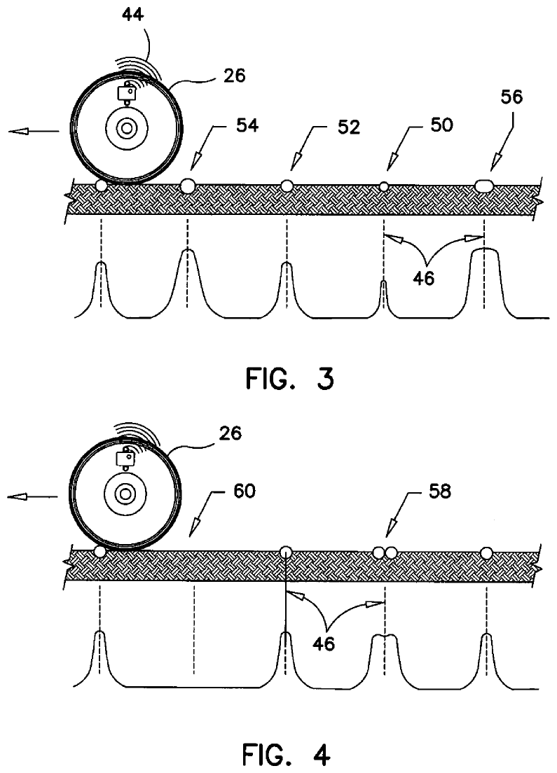

By interpreting this waveform 40 in parts or in combination of parts, one can determine whether the seed piece is a small 50, average 52 or a large seed piece 54. It is also possible to determine whether the seed piece has an oblong shape 56, a double seed drop 58 or a miss-seed/no-drop furrow space 60, as illustrated in FIGS. 3 and 4. This waveform 40 can also be analysed to determine planting events such as seed pieces imperfections such as a flat slice or sliver-like seed piece that does not have enough mass to germinate a sprout.

Moreover, the size and shape of a potato set can be determined at an early portion of the pressure signature 40, as mentioned before, so that in-furrow product delivery can start at a distance ahead of the seed piece, as illustrated in FIGS. 5-6.

Because of the lead time ‘A’ in reading a pressure sensor signal and obtaining an early estimation of the seed piece size as explained earlier, the in-furrow product delivery can start at a comfortable distance ‘A’ ahead of the planted seed piece 70, as shown in FIG. 5. The in-furrow product delivery can be increased ahead of the seed piece 70 if required, by reading and interpreting the strength of the slope of the curvature of the hyperbolic entry segment 42, as illustrated as a bump 72 along the band of in-furrow product in FIG. 5.

It will be appreciated that the controller is used in analysing the pressure sensor signal curve and in the timely delivering of a tailored quantity of in-furrow product. As illustrated, for some types of in-furrow products, in-furrow product delivery may stop over the planted seed as in FIG. 5 or can continue to spread it evenly over the seed piece in one continuous band 74, as in FIG. 6. The controller also controls the delivery of in-furrow product on the exit side of the seed piece, such as to generate a mirror-image reverse-delivery pattern from the pattern delivered on the entry side, for example, to obtain a symmetrical delivery of in-furrow product on both sides of the centroid 26. The controller preferably has an artificial intelligence neural network therein that can be trained to recognize an entire waveform from a glance at the hyperbolic entry segment 42 of a pressure signature 40 to further extend the lead time “A”.

The controller also adjusts the flow rate, the start time, the end time of in-furrow product delivery relative to the centroid 46 of each seed piece, according to the seed piece requirements. The controller further adjusts the flow rate relative to the distance ‘A’ between the seed piece and the end of the in-furrow product delivery spout 28′. And of course, the in-furrow product delivery system can be adjusted to deposit a dash of in-furrow product between planted seeds, or a continuous band varying in thickness according to the seed piece sizes detected.

In the present day, potato seed pieces are cut in bulk by machines, and therefore, it is common occurrence to see an oblong or an oversized seed piece as illustrated in FIG. 7. It is also common to find seed piece imperfections as mentioned before.

Such an elongated seed piece as in FIG. 7 is susceptible of having more than one potato eye 76, which will yield more than one sprout and more than one plant. Such an elongated seed piece needs more in-furrow product than a small or normal size seed piece. Similarly, a double drop seed pieces need more in-furrow product than a smaller size or average size seed piece.

Planted sets have root system that grow symmetrically relative to the centroid 45 of that plant. There is an advantage in delivering plant nutrient for example in a symmetrical manner relative to the centroid of each planted set, to feed all roots evenly to obtain evenly sized crop from each plant, and to obtain a same rate of growth of all seed pieces planted in this manner in a same field.

The pneumatic pressure sensor, the detection of the seed piece's centroid and the controller combination provides the means to tailor in-furrow product delivery to seed piece needs, according to their varieties, sizes, shape and spacings.

On the other hand, a miss-seed/no-drop furrow space or a flat, sliced, sliver-like seed does not need in-furrow product. Preventing the application of agricultural product over these regions results in savings. Again, the pneumatic pressure sensor and controller can tailor in-furrow product delivery to all potato seed planting events.

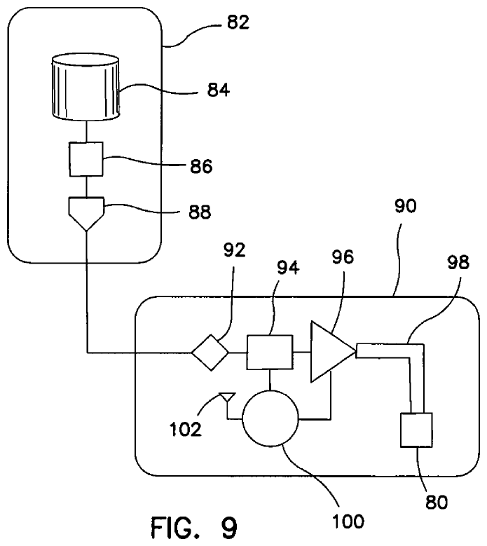

The preferred arrangement for a liquid form in-furrow product dispenser system comprises a Pulse-Width Modulation Nozzles TM 80 with a built-in solenoid in the nozzle. This type of nozzles is designed to operate at high frequencies, thus allowing for a fine control that is needed to apply in-furrow product to many seed pieces per second, at machine-planting speeds. Referring to FIG. 9, the preferred liquid in-furrow product dispensing system comprises; a planter module 82 including an in-furrow product tank 84, a pump 86 and a filter 88. A delivery module 90 includes a check valve 92, a flow meter 94, an actuator valve 96, an outlet hose 98 and a delivery nozzle 80. A controller 100 controls the delivery module and a wireless trigger switch 102 communicates with the controller. The planter module 82 can supply several delivery modules 90 on multi-row planters.

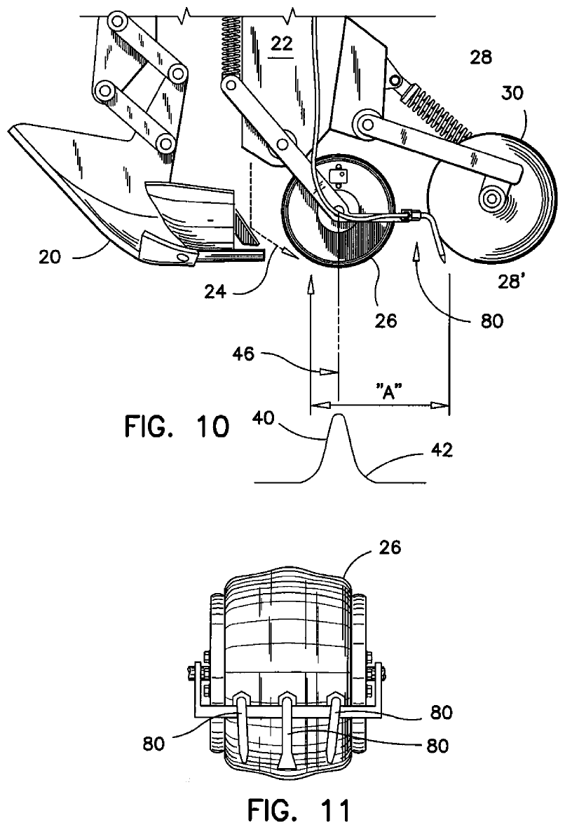

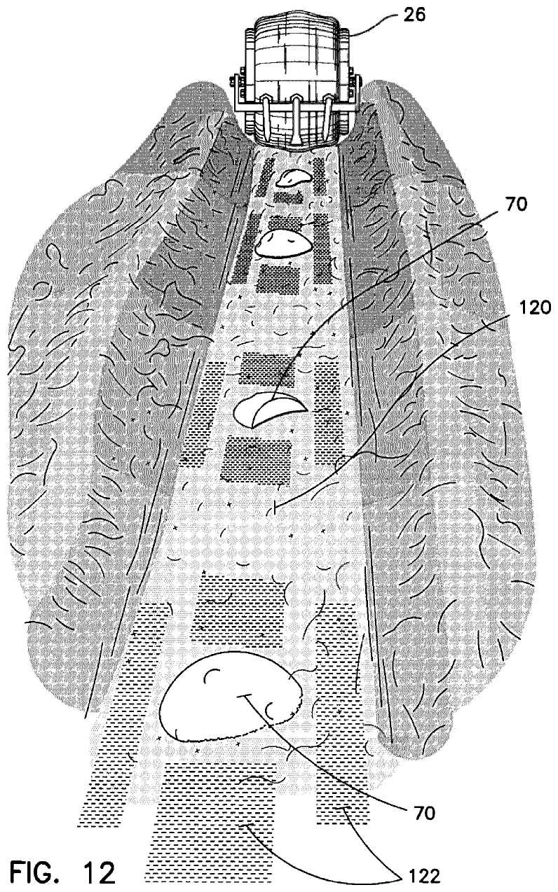

Referring to FIGS. 10 and 11, the nozzles 80 are mounted close to the press wheel 26, on a structure associated with the press wheel for example. The nozzles 80 are mounted at a distance from the press wheel 26 to afford a proper lead time “A” between a seed sensing and an in-furrow product delivery. As can be seen in FIG. 11, the type of nozzles 80 to be used, such as a fan, a pencil or a flute are of a designer's choice.

During experimentations, it has been found that a dispensing system response time between seed piece sensing and in-furrow liquid product flow is 35 to 90 milliseconds. To appreciate the value of this response time for example, an application of 7.5 cm (3 inches) long in-furrow product band between seed pieces that are spaced apart at 15 cm. (6 inches), at a travelling speed of 6 mph., would require a response time of 142 milliseconds between seed piece sensing and in-furrow product flow. Therefore, it is believed that the arrangement described in FIG. 9 can meet the most demanding seed planting scenario.

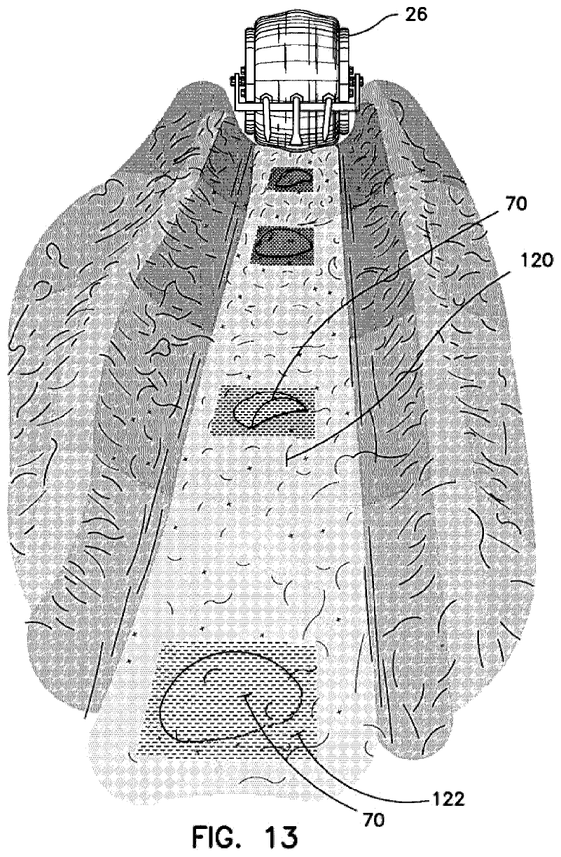

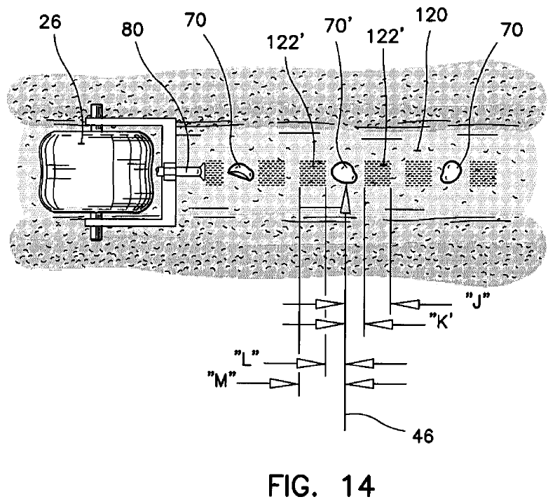

Referring now to FIGS. 12 and 13, the bottom surface 120 of a furrow following the passing of the press wheel 26, is flat, smooth, and even width, presenting a perfect rolled surface 120 upon which an agricultural product can be deposited precisely. The rolling of the press wheel against the bottom of the furrow to check the set roll of the planted sets and to tuck the planted set in the bottom of the furrow, partly covering the planted set there-under has the effect of reducing the permeability to liquids of the soil at the bottom of the furrow, surrounding of the planted sets. This surface is referred to as the planted surface 120. This planted surface 120 of a reduced permeability is somewhat flat, planar and has an even width, as illustrated in FIG. 12, and 13. The planted sets 70 are partly buried with only their crowns protruding through this planted surface 120.

This flat and wide planted surface 120 offers a stable platform to precisely apply in-furrow product relative to the seed piece needs and location. The reduced permeability of this planted surface 120 prevents to some degrees a fast leaching of the agricultural product through the soil, and a waste of the product. This reduced permeability to liquids is advantageous in many applications, and for example, when the in-furrow agricultural product applied is a bio-stimulant designed to be available at an early stage during root growth. The application of in-furrow products needed at a later stage of plant growth is also enhanced by this rolled planted surface 120.

Also because of this planar planted surface 120 of reduced permeability to liquids, it becomes possible to deposit in-furrow pesticides in contact with the planted sets or in a more concentrated application around the seed piece's immediate location, or both to extend the effective time of the product. This planted surface 120 together with a placement of in-furrow product relative to the centroid 46 of a planted set enables an in-furrow product placement that is tailored to maximize the efficiency of the product's relationship with the plant.

Examples of in-furrow product placement are shown in FIG. 12. The in-furrow product 122 can be applied in strips on each side on a planted set 70 or in dashes between planted sets, or in both ways.

Another placement of an in-furrow product, such as a pesticide for example, is deposited in patches over each planted sets and its surrounding area, as shown in FIG. 13.

In the examples illustrated in FIG. 12, and 13, all in-furrow product placements are done in symmetry with the centroid 46 of a planted set. As can be appreciate, the examples provided herein are only two possibilities amongst infinite number of in-furrow product placements.

In FIG. 14 there is illustrated a preferred delivery of in-furrow product to reduce waste. The in-furrow product to be delivered in each dash 122′ is calculated according to the signature produced by a respective planted set 70′. The delivery of the in-furrow product starts at a distance “J” from the centroid 46 of the planted set 70′ and stops at a distance “K” from the centroid 46. Once the nozzle 80 is passed the planted set 52′, in-furrow product delivery starts again at a distance “L” from the centroid 46 and stops at a distance “M” from the centroid 46. As can be seen in this example, in-furrow product delivery is symmetrical to the centroid 46 of a planted set in a horizontal plane of the planted surface. An in-furrow product delivery that based on a symmetry with the centroid of each planted sets increases the probabilities of an even absorption of this in-furrow product by the root system of the planted set 70′. Additional benefits of using an in-furrow product delivery that is based on a pneumatic signature and a symmetry relative to the centroids of planted sets are that the placement and amount of product can be tailored to produce an even growth of all planted sets in a same field, regardless of their spacings and regardless of their sizes and shapes.

The above description has demonstrated a placement of in-furrow product in a symmetrical manner relative to the centroid of a planted set, along a two-dimension plane of the planted surface 120. The symmetrical placement of in-furrow product in precision agriculture is done to delay the absorption of the product by a planted set until the roots of that planted set have grown sufficiently long to reach at least a vicinity of the in-furrow product. There are also advantages in delaying the leaching of the in-furrow product for a determined period after planting regardless of root length of the planted set. The reduced permeability mentioned above is a first level for achieving this control. In the preferred system according to the present invention, the in-furrow product can be deposited over a selective thickness of soil over a planted set during the closure of the furrow. The permeability of the soil and further leaching reduction offers a second level of control for delaying a contact of the in-furrow product with the planted set.

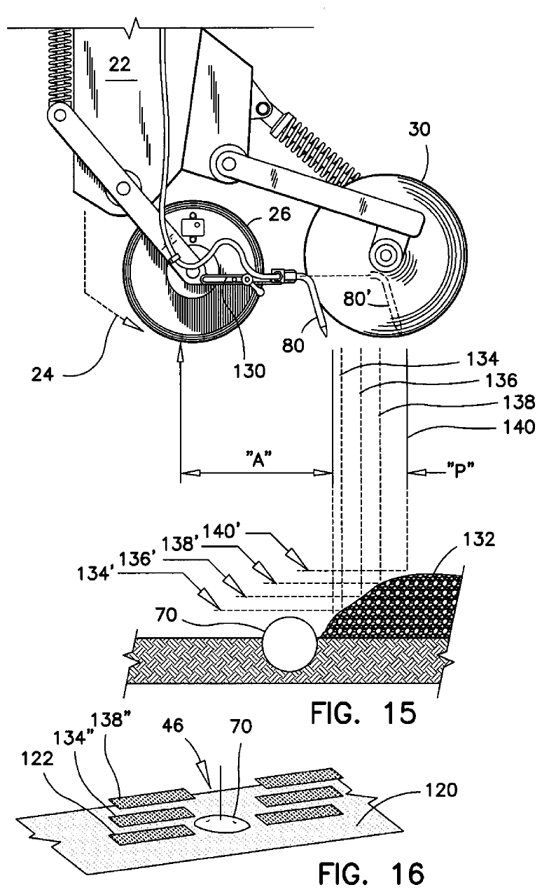

In FIG. 15, there is illustrated an in-furrow product delivery nozzle 80 that is mounted on an adjustable slide 130. The slide, or equivalent extensible device, is configured to adjust the nozzle 80 forward and backward between the closing discs 30, over a distance “P”, from a position 80 shown a solid line to a position 80′ shown in dashed line, or further away for example.

The amount of soil displaced by the closing discs 30 during the closing of a furrow is illustrated at label 132 in FIG. 15. It will be understood that the amount of soil 132 illustrated is an approximate representation of the amount of soil that is moving over the planted set 70 to cover the planted set 70.

When the nozzle 80 is adjusted at position 134 for example, the in-furrow product is deposited over a dusting of soil over the planted set 70 as illustrated at line 134′ in FIG. 15 and as layer 134″ in FIG. 16. When the nozzle 80 is adjusted at position 136, the in-furrow product is deposited over one inch of soil, for example, over the planted set, as illustrated by line 136′. The in-furrow product is deposited over two inches of soil for example in the position 138, 138′, and layer 138″ in FIG. 16. The in-furrow product is deposited on top of closed furrow in the example 140, 140′, Referring to FIG. 16, the in-furrow product is delivered in a third dimension according to a desired effect of a specific in-furrow product on a specific variety of seed pieces. In-furrow product application in a third dimension is still done in symmetry with the centroid 46 of the planted set whether it is deposited in a basic layer 122 directly on the floor of the planted surface 120 or in a third dimension.

In will be appreciated that adding two or more sets of nozzles in the region “P”, allows for the delivery of in-furrow product along two or more horizontal planes separated by layers of soil of selective thicknesses, for in-furrow product delivery to seed pieces at different stages of growth, for example.

Similarly, using two or more sets of nozzles allows for the delivery of in-furrow product to planted sets in a furrow along a combination of the product placements illustrated in the accompanying drawings, in two or three dimensions.

What is claimed is:

1. A method of operating a seed planter and dispensing in-furrow product to a planted set in a furrow comprising:
rolling an inflated press wheel over said planted set, wherein said press wheel having pressure measuring instrumentation mounted thereto;
causing said instrumentation to generate a pressure signature by said press wheel rolling over said planted set;
using a controller, analysing said pressure signature and determining from said step of analysing a characteristic of said planted set;
dispensing in-furrow product to said planted set according to said characteristic.

2. The method as claimed in claim 1, wherein said pressure signature has a period and an amplitude and said period and amplitude are interpreted to determine said characteristic.

3. The method as claimed in claim 1, wherein said pressure signature has a hyperbolic wave entry segment and said entry segment is interpreted to determine a size of said planted set.

4. The method as claimed in claim 1, wherein said pressure signature has an hyperbolic entry and exit segments, an elliptical crest between said hyperbolic entry and exit segments, a peak, a peak width, a period, an amplitude, a half-height, and a width at said half height, and said base width, said peak width, and said width at said half-height are interpreted to determine a size and shape of said planted set.

5. The method as claimed in claim 2, wherein said step of determining a characteristic of said planted set occurs at a distance ahead of said step of dispensing in-furrow product to said planted set.

6. The method as claimed in claim 1, wherein said characteristic of said planted set is determined from a group of characteristics comprising, as size of said planted set; a shape of said planted set, a double drop planted set, a no-drop furrow space, and a centroid of said planted set.

7. The method as claimed in claim 5, wherein said step of dispensing in-furrow product is done at different rate of dispensing, according to said characteristic.

8. The method as claimed in claim 6, wherein said step of dispensing in-furrow product is interrupted over said no-drop furrow space.

9. The method as claimed in claim 5, wherein said step of dispensing in-furrow product dispenses a band of in-furrow product ahead of said planted set and a band of in-furrow product on an exit side of said planted set and said band of in-furrow product dispensed ahead of said planted set is a mirror image of said band of in-furrow product dispensed on an exit side of said planted set.

10. A method of operating a seed planter and dispensing in-furrow product to a planted set in a furrow comprising:
rolling an inflated press wheel over said planted set, wherein said press wheel having pressure measuring instrumentation mounted thereto;
causing said instrumentation to generate a pressure signature by said press wheel rolling over said planted set;
using a controller, analysing said pressure signature and determining from said step of analysing a characteristic of said planted set;
dispensing in-furrow product to said planted set according to said characteristic, wherein said step of dispensing is done in symmetrical volume and symmetrical placements relative to a centroid of said planted set.

11. The method as claimed in claim 10, wherein said step of dispensing in-furrow product causes a dispensing of band of in-furrow product from an incoming side of said seed piece, over said seed piece and over an exit side of said seed piece.

12. The method as claimed in claim 11, wherein said step of rolling is done for forming a planar planted surface along a bottom of said furrow, wherein said planted surface has a reduced permeability to liquids.

13. The method as claimed in claim 12, wherein said planted surface partly covers said planted set.

14. A method of operating a seed planter and dispensing in-furrow product to a planted set in a furrow comprising:
rolling an inflated press wheel having pressure measuring instrumentation mounted thereto over said planted set;
causing said instrumentation to generate a pressure signature by said press wheel rolling over said planted set;
using an artificial intelligence algorithm and a controller, analysing a portion of said pressure signature from said press wheel and determining from said step of analysing a characteristic of said planted set;
dispensing in-furrow product to said planted set according to said characteristic of said planted set.

15. The method as claimed in claim 14, wherein said in-furrow product is a granular in-furrow product.

16. The method as claimed in claim 14 wherein said in-furrow product is a liquid in-furrow product.

17. The method as claimed in claim 15, wherein said portion of said pressure signature is a hyperbolic wave entry of said pressure signature.

18. The method as claimed in claim 16, wherein a response time between said step of causing said inflated press wheel to generate a pressure signature and said step of dispensing in-furrow product to said planted set is 35 to 90 milliseconds.

19. A method of operating a seed planter as claimed in claim 14, comprising the steps of;
identifying from said step of analysing said pressure signature a centroid of said planted set, and
dispensing in-furrow product to said planted set in symmetrical placements and symmetrical volumes relative to said centroid.

20. The method as claimed in claim 19, wherein said step of rolling is done for forming a planar planted surface of reduced permeability to liquids along a bottom of said furrow and said in-furrow product is dispensed on said planted surface.

21. A method for selective delivery of in-furrow products to a panted set in a furrow in 3 dimensional placement patterns using a seed planter wherein said seed planter has an inflated press wheel having pressure measuring instrumentation mounted thereto and a set of closing discs mounted behind said press wheel, and in-furrow dispensing nozzle mounted to said planter between said press wheel and said closing discs, comprising the steps of;
rolling said inflated press wheel over said planted set, and causing said instrumentation to generate a pressure signature by said press wheel rolling over said planted set;
using a controller, analysing said pressure signature and determining from said step of analysing a characteristic and a centroid of said planted set;
using said closing discs, adding a layer of soil over said planted set, and
dispensing said in-furrow product to said planted set according to said characteristic, over said layer of soil in symmetrical placement in a horizontal plane relative to said centroid.

22. The method as claimed in claim 21, where said step of adding a layer of soil comprises the step of adjusting a thickness of said layer of soil.
